(19) United States
(12) Patent Application Publication
(10) Pub. No.: US 2013/0243270 A1
(43) Pub. Date: Sep. 19, 2013

(54) SYSTEM AND METHOD FOR DYNAMIC ADAPTION OF MEDIA BASED ON IMPLICIT USER INPUT AND BEHAVIOR

(71) Applicants: Gila Kamhi, Zichron Yaakov (IL); Ron Ferens, Ramat Hasharon (IL)

(72) Inventors: Gila Kamhi, Zichron Yaakov (IL); Ron Ferens, Ramat Hasharon (IL)

(21) Appl. No.: 13/617,223

(22) Filed: Sep. 14, 2012

Related U.S. Application Data
(60) Provisional application No. 61/611,673, filed on Mar. 16, 2012.

(51) Int. Cl. G06K 9/00

(52) U.S. Cl. CPC G06K 9/00281
USPC 382/118

(57) ABSTRACT

A system and method for dynamically adapting media having multiple scenarios presented on a media device to a user based on characteristics of the user captured from at least one sensor. During presentation of the media, the at least one sensor captures user characteristics, including, but not limited to, physical characteristics indicative of user interest and/or attentiveness to subject matter of the media being presented. The system determines the interest level of the user based on the captured user characteristics and manages presentation of the media to the user based on determined user interest levels, selecting scenarios to present to the user on user interest levels.

### CROSS-REFERENCE TO RELATED APPLICATIONS

The present non-provisional application claims the benefit of U.S. Provisional Patent Application Ser. No. 61/611,673, filed Mar. 16, 2012, the entire disclosure of which is incorporated herein by reference.

### FIELD

The present disclosure relates to a system for media adaptation, and, more particularly, to a system and method for dynamic adaptation of media based on characteristics of a user during presentation of the media.

### BACKGROUND

With ongoing advances in technology, computing devices and electronics have become widely available. As such, the amount and variety of digital media available for such devices has increased. Some media may offer multiple scenarios in which the user may actively participate in deciding which scenario is presented. In the context of video games, for example, at particular points during gameplay, a user may be presented with one or more storylines from which the user may select, thereby providing a user with a variety of endings. Additionally, the storyline of a video game may change based on ongoing decisions made by the user during gameplay. Similarly, in the context of movies, some movies may include alternate endings from which a viewer may select. Providing a user with greater control over how media is presented to them, particularly providing multiple scenarios from which they may choose, may improve retention rates and replay-value. Some current systems and methods of adapting media based on user input, however, are limited. For example, some current systems and methods require active participation from the user to select a desired version of a media, which may be cumbersome and unappealing to some.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating one embodiment of a system for dynamically adapting media based on characteristics of a user during presentation of the media consistent with various embodiments of the present disclosure;

FIG. 2 is a block diagram illustrating another embodiment of a system for dynamically adapting media based on characteristics of a user during presentation of the media consistent with various embodiments of the present disclosure;

FIG. 3 is a block diagram illustrating the system of FIG. 1 in greater detail;

FIG. 4 is a block diagram illustrating one embodiment of a face detection module consistent with various embodiments of the present disclosure;

FIG. 5 is a block diagram illustrating one embodiment of a scenario selection module consistent with various embodiments of the present disclosure; and

FIG. 6 is a flow diagram illustrating one embodiment for selecting and presenting a scenario of media consistent with present disclosure.

### DETAILED DESCRIPTION

By way of overview, the present disclosure is generally directed to a system and method for dynamically adapting media having multiple scenarios presented on a media device to a user based on characteristics of the user captured from at least one sensor. During presentation of the media, the various sensors may capture particular attributes of the user, including, but not limited to, physical characteristics indicative of user interest and/or attentiveness to subject matter of the media being presented. The system may be configured to determine the interest level of the user based on the captured user attributes. The system may be further configured to manage presentation of the media to the user based on determined user interest levels, the system configured to determine presentation of a scenario of the media to the user based on user interest levels.

A system consistent with the present disclosure provides an automatic means of adapting playback of media to suit the interests of the user without requiring active input from the user (e.g. user response to a cue to make selection), thereby providing improved and intuitive interaction between a user and a media device presenting media to the user. Additionally, a system consistent with the present disclosure provides a tailored entertainment experience for the user, allowing a user to determine in real-time (or near real-time) a unique and dynamic version of presentment of the media.

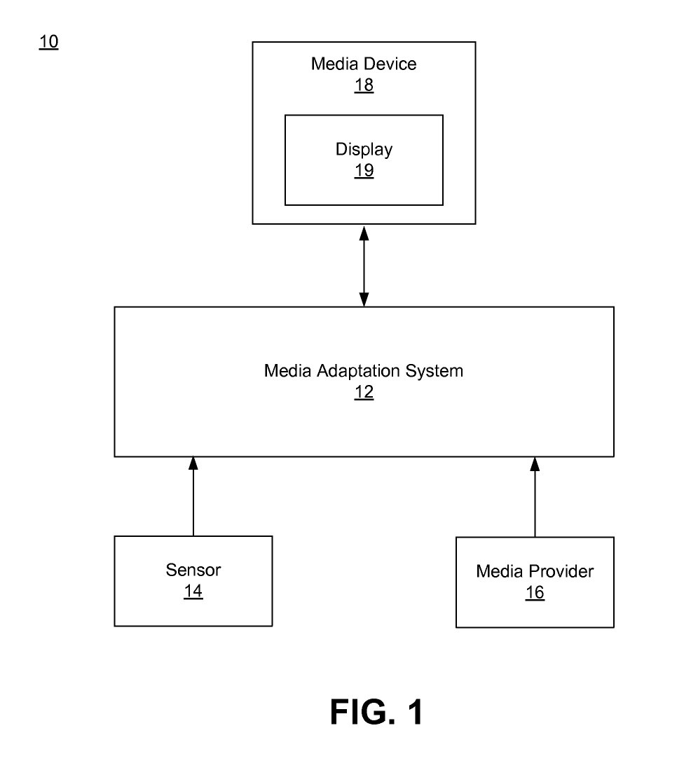

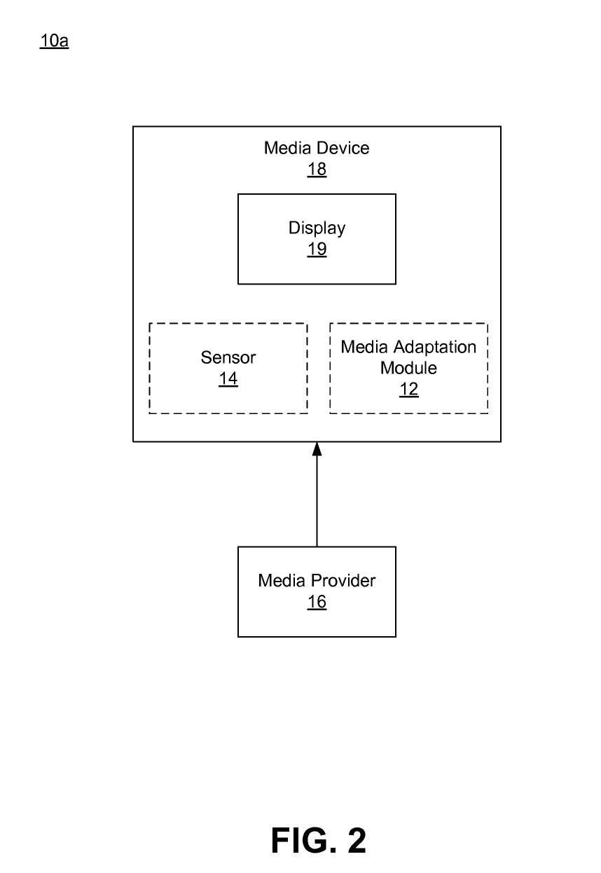

Turning to FIG. 1, one embodiment of a system 10 consistent with the present disclosure is generally illustrated. The system 10 includes a media adaptation module 12, at least one sensor 14, a media provider 16 and a media device 18. As discussed in greater detail herein, the media adaptation module 12 is configured to receive data captured from the at least one sensor 14 during presentation of media from the media provider 16 on a display 19, for example, of the media device 18. The media adaptation module 12 is configured to identify at least one characteristic of the user based on the captured data. The media adaptation module 12 is further configured to determine a level of interest of the user with respect to media presented on the media device 18. The media adaptation module 12 is further configured to adapt presentation of the media on the media device 18 based on the level of interest of the user. In the illustrated embodiment, the media adaptation module 12, at least one sensor 14 and media device 18 are separate from one another. It should be noted that in other embodiments, as generally understood by one skilled in the art, the media device 18 may optionally include the media adaptation module 12 and/or at least one sensor 14, as shown in FIG. 2, for example. The optional inclusion of media adaptation module 12 and/or at least one sensor 14 as part of the media device 18, rather than elements external to media device 18, is denoted in FIG. 2 with broken lines.

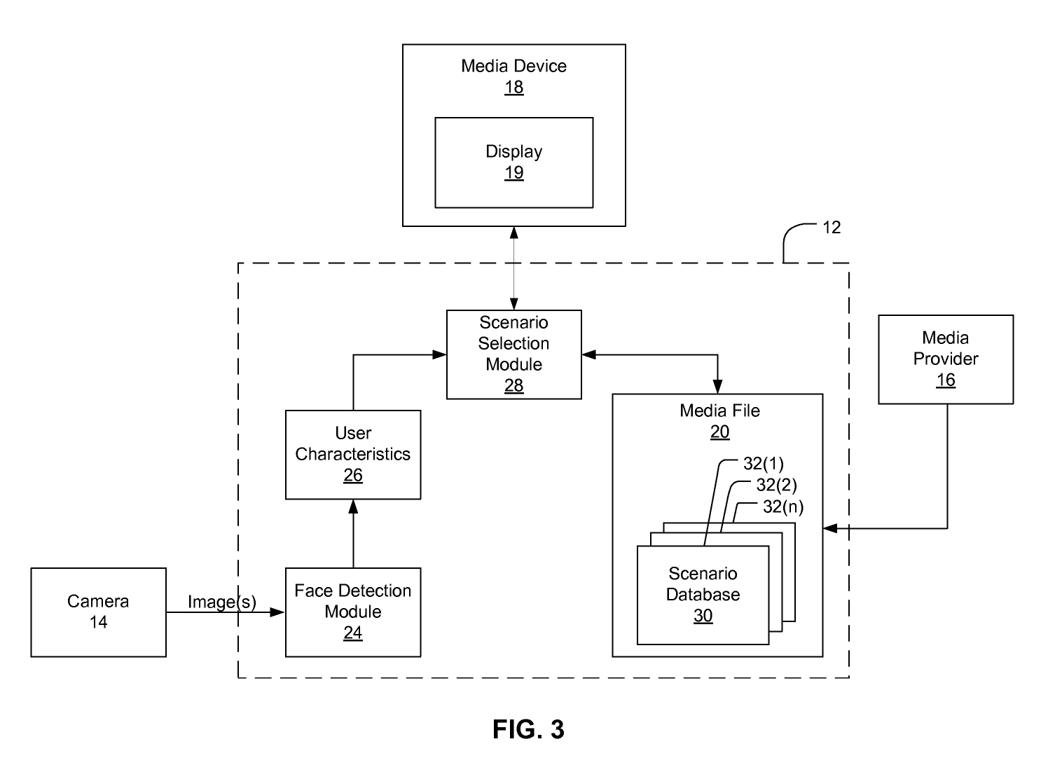

Turning now to FIG. 3, the system 10 of FIG. 1 is illustrated in greater detail. The media device 18 may be configured to provide video and/or audio playback of content provided by the media provider 16 to a user. In particular, the media provider 16 may provide one or more media file(s) 20 to be presented to the user visually and/or aurally on the media device 18 by way of the display 19 and/or speakers (not shown), for example. The media device 18 may include, but is not limited to, a television, an electronic billboard, a digital signage, a personal computer (PC), netbook, table, smart phone, portable digital assistant (PDA), portable media player (PMP), e-book, and other computing device.

The media device 18 may be configured to access one or more media files 20 provided by the media provider 16 via any known means, such as, for example, a wired connection or wireless connection. In one embodiment, the media device 18 may be configured to access media files 20 via a network (not shown). Non-limiting examples of suitable networks that may be used include the internet, private networks, virtual private networks (VPN), public switch telephone networks (PSTN), integrated services digital networks (ISDN), digital subscriber link networks (DSL), wireless data networks (e.g., cellular phone networks), other networks capable of carrying data, and combinations thereof. In some embodiments, network is chosen from the internet, at least one wireless network, at least one cellular telephone network, and combinations thereof.

The media provider 16 may include, but is not limited to, public and private websites, social networking websites, audio and/or video websites, combinations thereof, and the like that may provide content, such as, for example, video and/or audio content (e.g., video, music, gaming applications, etc.) executable on the media device 18. The media provider 16 may also include a selectable variety of consumer electronic devices, including, but not limited to, a personal computer, a video cassette recorder (VCR), a compact disk/digital video disk device (CD/DVD device), a cable decoder that receives a cable TV signal, a satellite decoder that receives a satellite dish signal, and/or a media server configured to store and provide various types of selectable programming.

The media file 20 may include any type of digital media presentable on the media device 18, such as, for example, video content (e.g., movies, television shows) audio content (e.g. music), e-book content, software applications, gaming applications, etc. In the following examples, the dynamic adaptation of a video file is described herein. It should be noted, however, that systems and methods consistent with the present disclosure also include the dynamic adaptation of other media, such as music, e-books and/or video games.

As previously discussed, the media adaptation module 12 is configured to receive data captured from at least one sensor 14. A system 10 consistent with the present disclosure may include a variety of sensors configured to capture various attributes of a user during presentation of a media file 20 on the media device 18, such as physical characteristics of a user that may be indicative of interest and/or attentiveness in regards to content of the media file 20. For example, in the illustrated embodiment, the media device 18 includes at least one camera 14 configured to capture one or more digital images of a user. The camera 14 includes any device (known or later discovered) for capturing digital images representative of an environment that includes one or more persons, and may have adequate resolution for face analysis of the one or more persons in the environment as described herein.

For example, the camera 14 may include a still camera (i.e., a camera configured to capture still photographs) or a video camera (i.e., a camera configured to capture a plurality of moving images in a plurality of frames). The camera 14 may be configured to capture images in the visible spectrum or with other portions of the electromagnetic spectrum (e.g., but not limited to, the infrared spectrum, ultraviolet spectrum, etc.). The camera 14 may include, for example, a web camera (as may be associated with a personal computer and/or TV monitor), handheld device camera (e.g., cell phone camera, smart phone camera (e.g., camera associated with the iPhone®, Trio®, Blackberry®, etc.), laptop computer camera, tablet computer (e.g., but not limited to, iPad®, Galaxy Tab®, and the like), e-book reader (e.g., but not limited to, Kindle®, Nook®, and the like), etc. It should be noted that in other embodiments, the system 10 may also include other sensors configured to capture various attributes of the user, such as, for example, one or more microphones configured to capture voice data of the user.

In the illustrated embodiment, the media adaptation module 12 may include a face detection module 24 configured to receive one or more digital images 22 captured by the camera 14. The face detection module 24 is configured to identify a face and/or face region within the image(s) 22 and, optionally, determine one or more characteristics of the user (i.e., user characteristics 26). While the face detection module 24 may use a marker-based approach (i.e., one or more markers applied to a user's face), the face detection module 24, in one embodiment, utilizes a markerless-based approach. For example, the face detection module 24 may include custom, proprietary, known and/or after-developed face recognition code (or instruction sets), hardware, and/or firmware that are generally well-defined and operable to receive a standard format image (e.g., but not limited to, a RGB color image) and identify, at least to a certain extent, a face in the image.

The face detection module 24 may also include custom, proprietary, known and/or after-developed facial characteristics code (or instruction sets) that are generally well-defined and operable to receive a standard format image (e.g., but not limited to, a RGB color image) and identify, at least to a certain extent, one or more facial characteristics in the image. Such known facial characteristics systems include, but are not limited to, standard Viola-Jones boosting cascade framework, which may be found in the public Open Source Computer Vision (OpenCV™) package. As discussed in greater detail herein, user characteristics 26 may include, but are not limited to, user behavior characteristics (e.g., but not limited to, gaze toward the display 19 of the media device 18, gaze towards specific subject matter displayed on the display 19 of the media device 18) and/or user expression characteristics (e.g., happy, sad, smiling, frown, surprised, excited, pupil dilation, etc.).

During presentation of the media file 20 on the media device 18, the media adaptation module 12 may be configured to continuously monitor the user and determine the user's reaction associated with the content of the media file 20 in real-time or near real-time. More specifically, the camera 14 may be configured to continuously capture one or more images 22 of the user and the face detection module 24 may continually establish user characteristics 26 based on the one or more images 22.

The media adaptation module 12 may include a scenario selection module 28 configured to analyze the user characteristics 26 in response to presentation of the media file 20 and determine a user's interest level associated with corresponding content of the media file 20 based on the user characteristics 26. As described in greater detail herein, the scenario selection module 28 may be configured to establish user interest levels associated with corresponding segments of the media file 20 (e.g., but not limited to, scenes of a movie, pages of a e-book, etc.) presented on the media device 18 and the associated content (e.g., but not limited to, character displayed in the movie scene, character described in the page, etc.). The scenario selection module 28 may be further configured to select one or more scenarios 32(1)-32(n) from a scenario database 30 of the media file 20 to present to the user based on the user interest levels. In other words, the presentation of the media file 20 may change depending on the interest level of the user in regards to subject matter being presented, thereby providing dynamic adaptation of the presentation of the media file 20.

In one embodiment consistent with the present disclosure, the media file 20 may include a movie (hereinafter referred to as “movie 20”), wherein the media adaptation module 12 may be configured to dynamically adapt the movie 20 based on a user's interest levels associated with content of the movie 20. The movie 20 may include a variety of scenarios 32 from which the media adaptation module 12 may select depending on a user's interest level associated with predefined scenes of the movie. Similar to alternate endings, the selection of different scenarios 32 will result in a variety changes in the overall storyline of the movie. More specifically, the movie 20 may include an overall storyline having one or more decision points included at predefined positions in the storyline. For example, certain scenes of the movie may be marked as a decision point, where the level of interest of a user in regards to the content of a scene is critical for a determination of how the storyline should flow. Each decision point may be associated with one or more scenarios 32. Each scenario 32 may include a different portion of the storyline of the movie 20 and may include content associated with a user's level of interest. Depending on the user's level of interest during a scene marked as a decision point, the storyline may change to so as to better adapt to the user's level of interest. More specifically, a scenario 32 may be selected that includes content that corresponds to the user's level if interest, thereby tailoring the movie to the interest of the user. Consequently, the movie 20 may include a variety of versions depending on a particular user's interest in content of the movie 20.

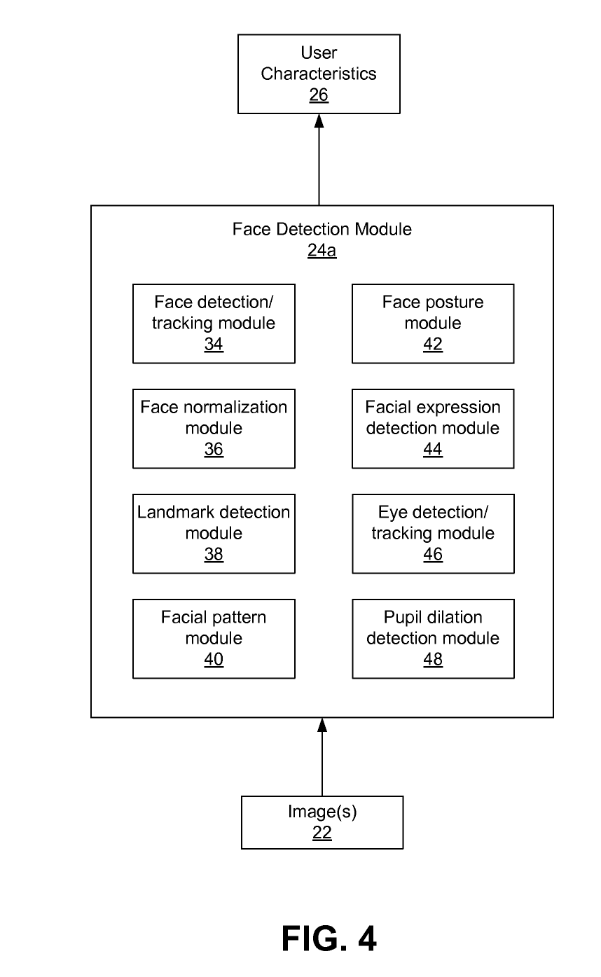

Turning now to FIG. 4, one embodiment of a face detection module 24a consistent with the present disclosure is generally illustrated. The face detection module 24a may be configured to receive an image 22 and identify, at least to a certain extent, a face (or optionally multiple faces) in the image 22. The face detection module 24a may also be configured to identify, at least to a certain extent, one or more facial characteristics in the image 22 and determine one or more user characteristics 26. The user characteristics 26 may be generated based on one or more of the facial parameters identified by the face detection module 24a as discussed herein. The user characteristics 26 may include, but are not limited to, user behavior characteristics (e.g., but not limited to, gaze toward the display 19 of the media device 18, gaze towards specific subject matter displayed on media device 18) and/or user expression characteristics (e.g., laughing, crying, smiling, frowning, surprised, excited, pupil dilation, etc.).

For example, one embodiment of the face detection module 24a may include a face detection/tracking module 34, a face normalization module 36, a landmark detection module 38, a facial pattern module 40, a face posture module 42 and a facial expression detection module 44. The face detection/tracking module 34 may include custom, proprietary, known and/or after-developed face tracking code (or instruction sets) that is generally well-defined and operable to detect and identify, at least to a certain extent, the size and location of human faces in a still image or video stream received from the camera 14. Such known face detection/tracking systems include, for example, the techniques of Viola and Jones, published as Paul Viola and Michael Jones, Rapid Object Detection using a Boosted Cascade of Simple Features, Accepted Conference on Computer Vision and Pattern Recognition, 2001. These techniques use a cascade of Adaptive Boosting (AdaBoost) classifiers to detect a face by scanning a window exhaustively over an image. The face detection/tracking module 34 may also track a face or facial region across multiple images 22.

The face normalization module 36 may include custom, proprietary, known and/or after-developed face normalization code (or instruction sets) that is generally well-defined and operable to normalize the identified face in the image 22. For example, the face normalization module 36 may be configured to rotate the image to align the eyes (if the coordinates of the eyes are known), crop the image to a smaller size generally corresponding the size of the face, scale the image to make the distance between the eyes constant, apply a mask that zeros out pixels not in an oval that contains a typical face, histogram equalize the image to smooth the distribution of gray values for the non-masked pixels, and/or normalize the image so the non-masked pixels have mean zero and standard deviation one.

The landmark detection module 38 may include custom, proprietary, known and/or after-developed landmark detection code (or instruction sets) that is generally well-defined and operable to detect and identify, at least to a certain extent, the various facial features of the face in the image 22. Implicit in landmark detection is that the face has already been detected, at least to some extent. Optionally, some degree of localization (for example, a course localization) may have been performed (for example, by the face normalization module 36) to identify/focus on the zones/areas of the image 22 where landmarks can potentially be found. For example, the landmark detection module 38 may be based on heuristic analysis and may be configured to identify and/or analyze the relative position, size, and/or shape of the eyes (and/or the corner of the eyes), nose (e.g., the tip of the nose), chin (e.g. tip of the chin), cheekbones, and jaw. Such known landmark detection systems include a six-facial points (i.e., the eye-corners from left/right eyes, and mouth corners) and six facial points (i.e., green points). The eye-corners and mouth corners may also be detected using Viola-Jones based classifier. Geometry constraints may be incorporated to the six facial points to reflect their geometry relationship.

The facial pattern module 40 may include custom, proprietary, known and/or after-developed facial pattern code (or instruction sets) that is generally well-defined and operable to identify and/or generate a facial pattern based on the identified facial landmarks in the image 22. As may be appreciated, the facial pattern module 40 may be considered a portion of the face detection/tracking module 34.

The face posture module 42 may include custom, proprietary, known and/or after-developed facial orientation detection code (or instruction sets) that is generally well-defined and operable to detect and identify, at least to a certain extent, the posture of the face in the image 22. For example, the face posture module 42 may be configured to establish the posture of the face in the image 22 with respect to the display 19 of the media device 18. More specifically, the face posture module 42 may be configured to determine whether the user's face is directed toward the display 19 of the media device 18, thereby indicating whether the user is observing the video 20 being displayed on the media device 18. The posture of the user's face may be indicative of the user's level of interest in the content of the movie 20 being presented. For example, if it is determined that the user is facing in a direction towards the display 19 of the media device 18, it may be determined that the user has a higher level of interest in the content of the movie 20 than if the user was not facing in a direction towards the display 19 of the media device 18.

The facial expression detection module 44 may include custom, proprietary, known and/or after-developed facial expression detection and/or identification code (or instruction sets) that is generally well-defined and operable to detect and/or identify facial expressions of the user in the image 22. For example, the facial expression detection module 44 may determine size and/or position of the facial features (e.g., eyes, mouth, cheeks, teeth, etc.) and compare the facial features to a facial feature database which includes a plurality of sample facial features with corresponding facial feature classifications (e.g., laughing, crying, smiling, frowning, excited, sad, etc.). The expressions of users may be associated with a level of interest in the content of the movie 20 being presented.

The face detection module 24a may also include an eye detection/tracking module 46 and a pupil dilation detection module 48. The eye detection/tracking module 46 may include custom, proprietary, known and/or after-developed eye tracking code (or instruction sets) that is generally well-defined and operable to detect and identify, at least to a certain extent, eye movement and/or eye focus of the user in the image 22. Similar to the face posture module 42, the eye detection/tracking module 46 may be configured to establish the direction in which the user's eyes are directed with respect to the display 19 of the media device 18. More specifically, the eye detection/tracking module 46 may be configured to determine whether the user's eyes are directed toward the display 19 of the media device 18, thereby indicating whether the user is observing the video 20 being displayed on the media device. The eye detection/tracking module 46 may be further configured to determine the particular area of the display 19 of the media device 18 in which the user's eyes are directed. Determination of the area of the display 19 upon which the user's eyes are directed may indicate the user's interest in specific subject matter positioned in that particular area of the display 19 during one or more scenes of the movie 20 being presented.

For example, a user may be interested in a particular character of the movie 20. During scenes associated with a decision point, the eye detection/tracking module 46 may be configured to track the movement of the user's eyes and identify a particular area of the display 19 in which the user's eyes are directed, wherein the particular area of the display 19 may be associated with, for example, the particular character of the movie 20 that interests the user.

The pupil dilation detection module 48 may include custom, proprietary, known and/or after-developed eye tracking code (or instruction sets) that is generally well-defined and operable to detect and identify, at least to a certain extent, characteristics of the eyes in the image 22. Implicit in pupil dilation detection is that the eye has already been detected, at least to some extent. Optionally, some degree of localization (for example, a course localization) may have been performed (for example, by the eye detection/tracking module 46) to identify/focus on eyes of the face of the image 22. For example, the pupil dilation detection module 48 may be based on heuristic analysis and may be configured to identify and/or analyze the relative position, size, and/or shape of the pupils of the eyes. As generally understood, changes in size of one's pupils may be indicative of a user's interest in the content of the movie 20 being presented on the media device 18. For example, dilation of the pupils may be indicative of an increased level of interest.

The face detection module 24a may generate user characteristics 26 based on or more of the parameters identified from the image 22. In one embodiment, the face detection module 24a may be configured to generate user characteristics 26 occurring at the predefined decision points in the storyline of the movie 20, thereby providing a user's reaction (e.g., but not limited to, user interest and/or attentiveness) to the content associated with a corresponding decision point. For example, the user characteristics 26 may include, but are not limited to, user behavior characteristics (e.g., but not limited to, gaze toward the display 19 of media device 18, gaze towards specific subject matter displayed on media device 18) and/or user expression characteristics (e.g., laughing, crying, smiling, frowning, surprised, excited, pupil dilation, etc.). The user characteristics 26 are used by the scenario selection module 28 to determine the user's level of interest in regards to the content of the movie 20 currently presented to the user and to select a scenario 32 of the movie 20 to present to the user based on the user's level of interest, as discussed herein.

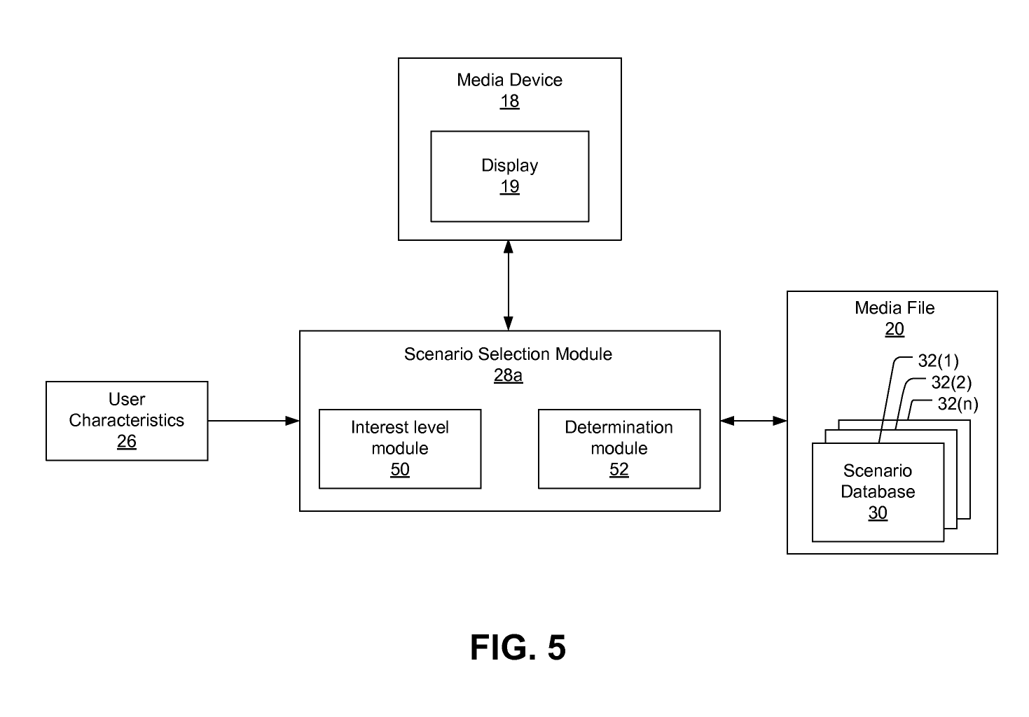

Turning now to FIG. 5, one embodiment of a scenario selection module 28a consistent with the present disclosure is generally illustrated. The scenario selection module 28a is configured to select at least one scenario 32 from the scenario database 30 of the movie 20 based, at least in part, on the user characteristics 26 identified by the face detection module 24. More specifically, the scenario selection module 28a may be configured to determine a user's level of interest in regards to content of a scene(s) based on the user characteristics 26 identified and generated by the face detection module 24 and select a scenario based on the user's level of interest.

In the illustrated embodiment, the scenario selection module 28a includes an interest level module 50 and a determination module 52. As described herein, the determination module 52 is configured to select a scenario 32 based, at least in part, on an analysis of the interest level module 50. The interest level module 50 may be configured to determine a user's interest level based on the user characteristics 26. For example, the interest level module 50 may be configured to analyze the user's behavior (e.g., but not limited to, gaze toward the display 19 of the media device 18, gaze towards specific subject matter displayed on media device 18) and/or the user's expressions (e.g., laughing, crying, smiling, frowning, surprised, excited, pupil dilation, etc.) during a decision point in the storyline of the movie 20 and determine an associated level of interest in the content displayed within the decision point timeframe.

For example, if the user characteristic data 26 indicates that the user is facing the display 19 of the media device 18 (e.g., as determined by the face posture module 42), the interest level module 50 may infer that the content of the movie 20 that the user is viewing is favorable, and therefore, the user has some interest. If the user characteristic data 26 indicates that the user is facing in a direction away from the display 19, the interest level module 50 may infer that the user has little or no interest in the content of the movie 20 being displayed. If the user characteristic data 26 indicates that the user is laughing, smiling, crying or frowning (e.g., as determined by the facial expression detection module 44), the interest level module 50 may infer that the user has some interest in the content of the movie 20 that the user is viewing. If the user characteristic data 26 indicates that the user is looking at a particular area of the display 19 (e.g., as determined by the eye detection/tracking module 46), the interest level module 50 may infer that the user has some interest in the subject matter (e.g. a character) of that area of the display 19. If the user characteristic data 26 indicates that the user's pupils are dilating or the diameter is increasing (e.g., as determined by the pupil dilation detection module 48), the interest level module 50 may infer that the user has some interest in the content of the movie 20 being displayed.

The determination module 52 may be configured to weigh and/or rank interest levels associated with the user characteristics 26 from the interest level module 50 and identify a scenario 32 to present the user based on the interest levels. For example, the determination module 52 may select a scenario 32 from a set of scenarios 32(1)-32(n) based on a heuristic analysis, a best-fit type analysis, regression analysis, statistical inference, statistical induction, and/or inferential statistics.

In one embodiment, the interest level module 50 may be configured to generate an overall interest level of the user. If the overall interest level meets or exceeds a first pre-defined threshold value or falls below a second pre-defined threshold value, the determination module 52 may be configured to identify a scenario 32 associated with the overall interest level so as to adapt the storyline of the movie 20 to better fit the interest of the user. For example, if it is determined that the user has a high interest level in a particular character when viewing one or more scenes associated with a decision point, the determination module 52 may be configured to identify a scenario 32 corresponding to the high interest level of the user, wherein the scenario 32 may include scenes having more focus on the character of interest. It should be appreciated that the determination module 52 does not necessarily have to consider all of the user characteristic data 26 when determining and selecting a scenario 32.

By way of example, if the overall interest level fails to meet or exceed the first pre-defined threshold value and fails to fall below the second pre-defined threshold value, the determination module 52 may default to presenting a natural progression of the storyline of the movie 32 and not actively select different scenarios 32 to present to the user. Of course, these examples are not exhaustive, and the determination module 52 may utilize other selection techniques and/or criterion.

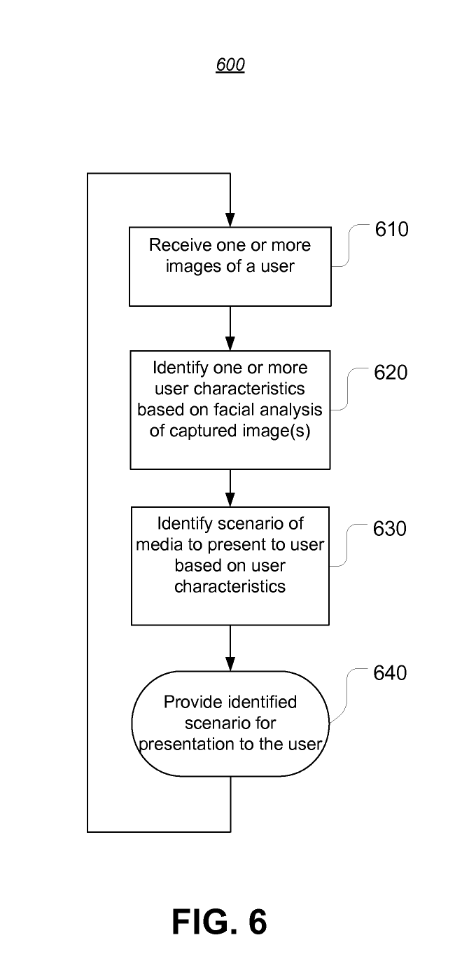

Turning now to FIG. 6, a flowchart of one embodiment of a method 600 for selecting and presenting a scenario of media consistent with the present disclosure is illustrated. The method 600 includes receiving one or more images of a user (operation 610). The images may be captured using one or more cameras. A face and/or face region may be identified within the captured image and at least one user characteristic may be determined (operation 620). In particular, the image may be analyzed to determine one or more of the following user characteristics: the user's behavior (e.g., gaze toward a display of a media device, gaze towards specific subject matter of content displayed on media device); and/or user's emotion identification (e.g., laughing, crying, smiling, frowning, surprised, excited, pupil dilation, etc.).

The method 600 also includes identifying a scenario of a media file to present to the user based on the user characteristics (operation 630). For example, the method 600 may determine an interest level of the user based on the user characteristics and identify a particular scenario of the media file to present to a user. The method 600 further includes providing the identified scenario for presentation to the user (operation 640). The identified scenario may be presented to the user on a media device, for example. The method 600 may then repeat itself.

While FIG. 6 illustrates method operations according various embodiments, it is to be understood that in any embodiment not all of these operations are necessary. Indeed, it is fully contemplated herein that in other embodiments of the present disclosure, the operations depicted in FIG. 6 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

A system and method consistent with the present disclosure provides a means of adapting playback of media to suit the interests of the user without requiring active input from the user (e.g. user response to a cue to make selection), thereby providing improved and intuitive interaction between a user and a media device presenting media to the user. In particular, the system and method provides dynamic adaptation of the storyline of the media, such as, for example, a movie or book, resulting in a variety of versions of the same movie or book, increasing retention rates and improving replay-value. Additionally, a system consistent with the present disclosure provides a tailored entertainment experience for the user, allowing a user to experience in real-time (or near real-time) a unique and dynamic version of presentment of the media.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

According to one aspect of the present disclosure, there is provided an apparatus for dynamically adapting presentation of media to a user. The apparatus includes a face detection module configured to receive an image of a user and detect a facial region in the image and identify one or more user characteristics of the user in the image. The user characteristics are associated with corresponding subject matter of the media. The apparatus further includes a scenario selection module configured to receive data related to the one or more user characteristics and select at least one of a plurality of scenarios associated with media for presentation to the user based, at least in part, on the data related to the one or more user characteristics

Another example apparatus includes the foregoing components and the scenario selection module includes an interest level module configured to determine a user's level of interest in the subject matter of the media based on the data related to the one or more user characteristics and a determination module configured to identify the at least one scenario for presentation to the user based on the data related to the user's level of interest, the at least one identified scenario having subject matter related to subject mater of interest to the user. Another example apparatus includes the foregoing components and the received image of the user comprises information captured by a camera during presentation of the media to the user.

Another example apparatus includes the foregoing components and the scenario selection module is configured to provide the at least one selected scenario to a media device having a display for presentation to the user.

Another example apparatus includes the foregoing components and the one or more user characteristics are selected from the group consisting of face direction and movement of the user relative to the display, eye direction and movement of the user relative to the display, focus of eye gaze of the user relative to the display, pupil dilation of the user and one or more facial expressions of the user.

Another example apparatus includes the foregoing components and the face detection module is further configured to identify one or more regions of the display upon which the user's eye gaze is focused during presentation of the media, wherein identified regions are indicative of user interest in subject matter presented within the identified regions of the display.

Another example apparatus includes the foregoing components and the one or more facial expressions of the user are selected from the group consisting of laughing, crying, smiling, frowning, surprised and excited.

Another example apparatus includes the foregoing components and the face detection module is configured to identify the one or more user characteristics of the user at predefined decision points during presentation of the media.

Another example apparatus includes the foregoing components and the media includes a video file having a plurality of video frames.

Another example apparatus includes the foregoing components and each of the predefined decision points correspond to one or more associated video frames of the video file.

Another example apparatus includes the foregoing components and one or more video frames of the video file correspond to the at least one scenario.

According to another aspect there is provided at least one computer accessible medium including instructions stored thereon. When executed by one or more processors, the instructions may cause a computer system to perform operations for dynamically adapting presentation of media to a user. The operations include receiving an image of a user, detecting a facial region in the image of the user, identifying one or more user characteristics of the user in the image, the one or more user characteristics are associated with corresponding subject matter of the media, identifying at least one of a plurality of scenarios associated with media for presentation to the user based, at least in part, on the identified one or more user characteristics and providing the at least one identified scenario for presentation to the user.

Another example computer accessible medium includes the foregoing operations and further includes analyzing the one or more user characteristics and determining the user's level of interest in the subject matter of the media based on the one or more user characteristics.

Another example computer accessible medium includes the foregoing operations and identifying a scenario of the media for presentation to the user further includes analyzing the user's level of interest in the subject matter and identifying at least one of a plurality of scenarios of the media having subject matter related to the subject mater of interest to the user based on the user's level of interest.

Another example computer accessible medium includes the foregoing operations and further includes detecting a facial region in an image of the user captured at one of a plurality of predefined decision points during presentation of the media to the user and identifying one or more user characteristics of the user in the image.

According to another aspect of the present disclosure, there is provided a method for dynamically adapting presentation of media to a user. The method includes receiving, by a face detection module, an image of a user and detecting, by the face detection module, a facial region in the image of the user and identifying, by the face detection module, one or more user characteristics of the user in the image. The one or more user characteristics are associated with corresponding subject matter of the media. The method further includes receiving, by a scenario selection module, data related to the one or more user characteristics of the user and identifying, by the scenario selection module, at least one of a plurality of scenarios associated with media for presentation to the user based on the data related to the one or more user characteristics and providing, by the scenario selection module, the at least one identified scenario for presentation to the user.

Another example method includes the foregoing operations and the scenario selection module includes an interest level module and a determination module.

Another example method includes the foregoing operations and further includes analyzing, by the interest level module, the data related to the one or more user characteristics and determining, by the interest level module, the user's level of interest in the subject matter of the media based on the data related to the one or more user characteristics.

Another example method includes the foregoing operations and further includes analyzing, by the determination module, the user's level of interest in the subject matter and identifying, by the determination module, at least one of a plurality of scenarios of the media having subject matter related to the subject mater of interest to the user based on the user's level of interest.

Another example method includes the foregoing operations and the received image of the user includes information captured by a camera during presentation of the media to the user.

Another example method includes the foregoing operations and the providing the at least one identified scenario for presentation to the user includes transmitting data related to the identified scenario to a media device having a display for presentation to the user.

Another example method includes the foregoing operations and the user characteristics are selected from the group consisting of face direction and movement of the user relative to the display, eye direction and movement of the user relative to the display, focus of eye gaze of the user relative to the display, pupil dilation of the user and one or more facial expressions of the user.

Another example method includes the foregoing operations and the identifying one or more user characteristics of the user in the image includes identifying, by the face detection module, one or more regions of a display upon which the user's eye gaze is focused during presentation of the media on the display, wherein identified regions are indicative of user interest in subject matter presented within the identified regions of the display.

Another example method includes the foregoing operations and the one or more facial expressions of the user are selected from the group consisting of laughing, crying, smiling, frowning, surprised and excited.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present disclosure should not be limited by any of the above-described exemplary embodiments, but should be defined only in accordance with the following claims and their equivalents.

What is claimed is:

1. An apparatus for dynamically adapting presentation of media to a user, said apparatus comprising:
a face detection module configured to receive an image of a user and detect a facial region in said image and identify one or more user characteristics of said user in said image, said user characteristics being associated with corresponding subject matter of said media; and
a scenario selection module configured to receive data related to said one or more user characteristics and select at least one of a plurality of scenarios associated with media for presentation to said user based, at least in part, on said data related to said one or more user characteristics.

2. The apparatus of claim 1, wherein said scenario selection module comprises:
an interest level module configured to determine a user's level of interest in said subject matter of said media based on said data related to said one or more user characteristics; and
a determination module configured to identify said at least one scenario for presentation to said user based on said data related to said user's level of interest, said at least one identified scenario having subject matter related to subject mater of interest to said user.

3. The apparatus of claim 1, wherein said received image of said user further comprises information captured by a camera during presentation of said media to said user.

4. The apparatus of claim 1, wherein said scenario selection module is configured to provide said at least one selected scenario to a media device having a display for presentation to said user.

5. The apparatus of claim 4, wherein said one or more user characteristics are selected from the group consisting of face direction and movement of said user relative to said display, eye direction and movement of said user relative to said display, focus of eye gaze of said user relative to said display, pupil dilation of said user and one or more facial expressions of said user.

6. The apparatus of claim 5, wherein said face detection module is further configured to identify one or more regions of said display upon which said user's eye gaze is focused during presentation of said media, wherein identified regions are indicative of user interest in subject matter presented within said identified regions of said display.

7. The apparatus of claim 5, wherein said one or more facial expressions of said user are selected from the group consisting of laughing, crying, smiling, frowning, surprised and excited.

8. The apparatus of claim 1, wherein said face detection module is configured to identify said one or more user characteristics of said user at predefined decision points during presentation of said media.

9. The apparatus of claim 8, wherein said media comprises a video file having a plurality of video frames.

10. The apparatus of claim 9, wherein each of said predefined decision points correspond to one or more associated video frames of said video file.

11. The apparatus of claim 9, wherein one or more video frames of said video file correspond to said at least one scenario.

12. At least one computer accessible medium storing instructions which, when executed by a machine, cause the machine to perform operations for dynamically adapting presentation of media to a user, said operations comprising:
receiving an image of a user;
detecting a facial region in said image of said user;
identifying one or more user characteristics of said user in said image, said one or more user characteristics being associated with corresponding subject matter of said media;
identifying at least one of a plurality of scenarios associated with media for presentation to said user based, at least in part, on said identified one or more user characteristics; and
providing said at least one identified scenario for presentation to said user.

13. The computer accessible medium of claim 12, further comprising:
analyzing said one or more user characteristics and determining said user's level of interest in said subject matter of said media based on said one or more user characteristics.

14. The computer accessible medium of claim 13, wherein identifying a scenario of said media for presentation to said user comprises:
analyzing said user's level of interest in said subject matter and identifying at least one of a plurality of scenarios of said media having subject matter related to said subject mater of interest to said user based on said user's level of interest.

15. The computer accessible medium of claim 12, further comprising:
detecting a facial region in an image of said user captured at one of a plurality of predefined decision points during presentation of said media to said user and identifying one or more user characteristics of said user in said image.

16. A method for dynamically adapting presentation of media to a user, said method comprising:
receiving, by a face detection module, an image of a user;
detecting, by said face detection module, a facial region in said image of said user;
identifying, by said face detection module, one or more user characteristics of said user in said image, said one or more user characteristics being associated with corresponding subject matter of said media;
receiving, by a scenario selection module, data related to said one or more user characteristics of said user;
identifying, by said scenario selection module, at least one of a plurality of scenarios associated with media for presentation to said user based on said data related to said one or more user characteristics; and
providing, by said scenario selection module, said at least one identified scenario for presentation to said user.

17. The method of claim 16, wherein said scenario selection module comprises an interest level module and a determination module.

18. The method of claim 17, further comprising:
analyzing, by said interest level module, said data related to said one or more user characteristics and determining, by said interest level module, said user's level of interest in said subject matter of said media based on said data related to said one or more user characteristics.

19. The method of claim 18, wherein identifying at least one scenario comprises:
analyzing, by said determination module, said user's level of interest in said subject matter and identifying, by said determination module, at least one of a plurality of scenarios of said media having subject matter related to said subject mater of interest to said user based on said user's level of interest.

20. The method of claim 16, wherein said received image of said user comprises information captured by a camera during presentation of said media to said user.

21. The method of claim 16, wherein providing said at least one identified scenario for presentation to said user comprises transmitting data related to said identified scenario to a media device having a display for presentation to said user.

22. The method of claim 21, wherein said user characteristics are selected from the group consisting of face direction and movement of said user relative to said display, eye direction and movement of said user relative to said display, focus of eye gaze of said user relative to said display, pupil dilation of said user and one or more facial expressions of said user.

23. The method of claim 22, wherein said identifying one or more user characteristics of said user in said image comprises:
identifying, by said face detection module, one or more regions of a display upon which said user's eye gaze is focused during presentation of said media on said display, wherein identified regions are indicative of user interest in subject matter presented within said identified regions of said display.

24. The method of claim 22, wherein said one or more facial expressions of said user are selected from the group consisting of laughing, crying, smiling, frowning, surprised and excited.
